(19) United States
(12) Patent Application Publication
(10) Pub. No.: US 2004/0203678 A1
(43) Pub. Date: Oct. 14, 2004

(54) Method for effecting fast forward no-answer treatment for wireless or wireline calls

(76) Inventors: John J. MacNamara, Orland Park, IL (US); Randall Joe Wilson, Naperville, IL (US)

Correspondence Address: Docket Administrator (Room. 3J-219), Lucent Technologies Inc., 101 Crawfords Corner Road, Holmdel, NJ, 07733-3030, US

(21) Appl. No.: 10/209,241

(22) Filed: Jul. 31, 2002

(51) Int. Cl. H04M 3/42

(52) U.S. Cl. 455/417; 455/413; 455/414.1

(57) ABSTRACT

A method for providing expedited (or “fast forwarded”) no-answer treatment for certain calls. A calling party (108 or 110) requests expedited no-answer treatment prior to or during a ring sequence of a called party phone (108 or 110). Depending on the request and availability, a terminating office (116 or 124) routes the call per the expedited no-answer treatment. The no-answer treatment may comprise, for example, interrupting the ring sequence and routing the call to a voice mailbox (126) or to a forwarding number of the called party.

### FIELD OF THE INVENTION

This invention relates generally to the field of communication systems and, more particularly, to a method that permits expedited (or “fast forward”) no answer treatment for wireless or wireline calls.

### BACKGROUND OF THE INVENTION

Communication systems are well known in which a calling party (using, for example, a wireless or wireline phone) may initiate a telephone call to a called party (also using, for example, a wireless or wireline phone). A typical call is implemented by the calling party dialing a directory number associated with the called party's phone, thereby effecting a series of rings on the called party's phone. The ring sequence is interrupted if the call is answered by the called party, or if the calling party hangs up during the ringing sequence, as is well known. Otherwise, if the called party is not available or is not answering the phone, the ring sequence continues for a period of time (usually, at least 3-4 rings). Oftentimes, after the series of rings is concluded, the communication system effects no-answer treatment for the attempted call. No-answer treatment may comprise, for example, forwarding the call to a voice mailbox associated with the called phone (such that the calling party may leave a voicemail message for the called party) or directing the calling party to a forwarded directory number of the called party. The no-answer treatment may differ for different call scenarios (for example, busied calls vs. calls not answered after a series of rings) or for different called parties depending on preferences or settings of the called parties.

A problem that arises is that the ring sequence of a called party phone can take several seconds to complete and, hence, several seconds to commence no-answer treatment. This can be frustrating at times for the calling party, particularly when the calling party knows or believes that the called party is unavailable or not answering, or where the calling party prefers to leave a voicemail message rather than speak directly with the called party. A related problem is that when no-answer treatment is preceded by fully executed ring sequences (particularly when the ring sequences are not needed or desired), network resources are unnecessarily burdened which may negatively impact the capacity of the network to support other calls.

### SUMMARY OF THE INVENTION

This problem is solved and a technical advance is achieved in the art by a feature whereby no-answer treatment may be expedited (or “fast forwarded”) for certain calls. In one embodiment, a calling party requests expedited no-answer treatment during a ring sequence of a called party phone. The no-answer treatment may comprise, for example, directing the call to a voice mailbox or to a forwarding number of the called party. In one embodiment, the request effects a “default” no-answer treatment that is nominally associated with the called party phone. A terminating office for the call consults a database to identify the default no-answer treatment and the call is routed per the default no-answer treatment. Alternatively, the calling party may request a desired type of no-answer treatment, which may differ from the default no-answer treatment normally associated with the called party phone. The requested treatment may be selected from a plurality of call treatment options. The terminating office consults a database to identify an availability of the desired treatment and, if available, provides the desired treatment. Optionally, if the desired treatment is not available, the terminating office provides a default treatment associated with the called party phone.

In yet another embodiment, the calling party may request a type of call treatment for a prospective call prior to ringing the called party phone. A terminating office determines an availability of the requested no-answer treatment and, if available, the requested no-answer treatment is provided upon routing a call to the called party. The availability of the requested no-answer treatment may be determined, optionally, based on various call treatments identified in a subscriber database.

In still another embodiment, a service provider constructs a database mapping subscribers to various default no-answer treatments. For example, the database may identify a certain expedited call treatment for a certain directory number or a group of directory numbers. The type of call treatment(s) identified in the database may be based on request(s) of the subscribers or may be set autonomously by the service provider, responsive to network loading conditions or other factors.

### BRIEF DESCRIPTION OF THE DRAWINGS

The foregoing and other advantages of the invention will become apparent upon reading the following detailed description and upon reference to the drawings in which:

FIG. 1 is a block diagram of a communication system in which several embodiments of the present invention may be implemented;

FIG. 2 is a flowchart of a first embodiment of the invention wherein a calling party effects expedited no-answer treatment during a ring sequence of a called party phone;

FIG. 3 is a flowchart of a second embodiment of the invention wherein a calling party effects expedited no-answer treatment in advance of ringing a called party phone; and

FIG. 4 is a flowchart of a third embodiment of the invention wherein a service provider effects expedited no-answer treatment of a called party phone.

### DESCRIPTION OF THE PREFERRED EMBODIMENT(S)

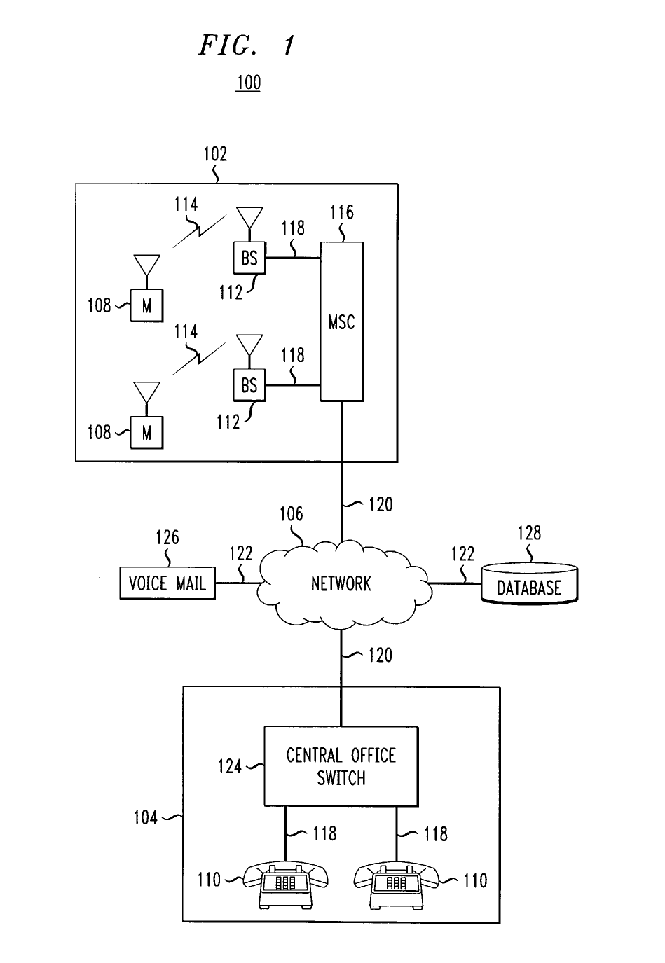

FIG. 1 shows by way of example and not limitation, a communication system 100 comprising a wireless subsystem 102 and a wireline subsystem 104 interconnected by a network 106. The wireless and wireline subsystems 102, 104 may comprise private systems or public systems or a combination thereof. The network 106 may be implemented using any appropriate transmission, switching and routing technologies, as are known in the art, including but not limited to Internet Protocol (IP) and Asynchronous Transfer Mode (ATM) technologies.

Distributed throughout the wireless subsystem 102 is a plurality of mobile units (e.g., cell phones) 108. Distributed throughout the wireline system 104 is a plurality of wireline units 110 (e.g., telephones, fax machines and the like). Generally, any of the mobile or wireline units 108, 110 may be sources or recipients of calls. Depending on the call, as will be appreciated, the source(s) and recipient(s) may each reside in the wireless network 102 or the wireline network 104, or the source(s) and recipients may be divided among the wireless and wireline networks.

Wireless subsystem 102 comprises in one embodiment, a digital cellular communication system. The mobile units 108, generally, are adapted to roam between different RF coverage areas of the wireless subsystem, sometimes referred to as “cells” (not shown) served by base stations 112. The wireless subsystem 102 may include multiple base stations 112 serving multiple cells. Wireless calls to (or from) the mobile units 108 are communicated via RF resources 114 from (or to) the base stations, typically by a predefined wireless protocol such as, for example, Global System for Mobile Communications (GSM), Personal Communications Service (PCS), Code Division Multiple Access (CDMA), Time Division Multiple Access (TDMA) and Advanced Mobile Phone Service (AMPS).

The base stations 112 are connected via links 118 to a call processing control entity, commonly known as a mobile switching center (MSC) 116, which routes the calls, as may be appropriate, to or from the network 106 and the wireline subsystem 104. The links 118 may comprise, without limitation, conventional subscriber lines, ISDN lines, Ethernet LAN, and the like. The MSC 116 may comprise, for example, a 5ESS® switching system, available from Lucent Technologies, Inc. The MSC 116 includes a memory and processor (not shown), for storing and executing software routines for processing and switching calls, for providing various call features to calling parties and for providing access to the network 106 and wireline subsystem 104. The MSC 116 may be configured for operation with generally any suitable circuit, cell, or packet switching technology.

Wireline subsystem 104 comprises in one embodiment the public switched telephone network (PSTN). The wireline units 110 of the PSTN are connected via links 118 to a local call processing control entity commonly referred to as a central office switch 124. The links 118 may comprise, without limitation, conventional subscriber lines, ISDN lines, Ethernet LAN, and the like. The central office switch 124 may comprise, for example, a 5ESS® switching system, available from Lucent Technologies, Inc. The central office switch 124 includes a memory and processor (not shown), for storing and executing software routines for processing and switching calls, for providing various call features to wireline units 110 and for providing access to the network 106 and wireless subsystem 102.

As shown, the communication system 100 of FIG. 1 includes a single MSC 116 and single central office switch 124. However, as will be appreciated, the MSC 116 and central office switch 124 are functional entities that may reside in multiple physical switches or combined into a single switch.

Links 120 carry signaling information and/or payload information between central office switch 124 and network 106, and/or between MSC 116 and network 106. In one embodiment, the payload information comprises voice information. Alternatively or additionally, the payload information may comprise information associated with video, data, text or generally any communication media. The links 120 are logical links that may be physically realized, without limitation, by conventional subscriber lines, ISDN lines, WAN links, wireless links, and the like.

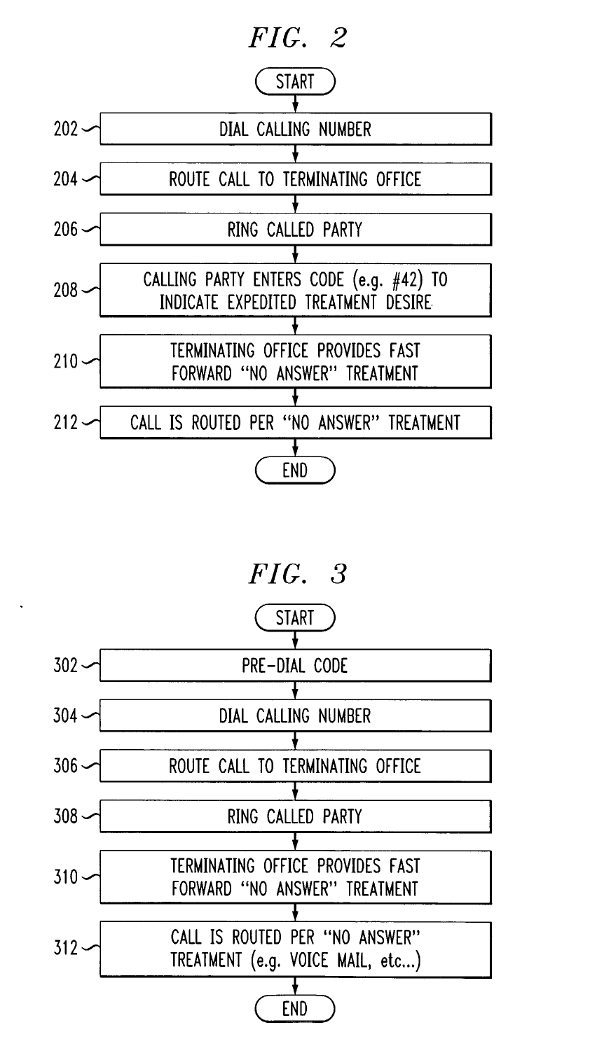

As shown, data links 122 connect the network 106 to a messaging system 126 (such as a voice mail system) and a database 128. In one embodiment, as will be described in greater detail in relation to FIGS. 2-4, the database 128 stores information associated with no-answer treatment(s) for certain prospective called parties, which prospective called parties may comprise wireless or wireline units 108, 110. The data links 122 may comprise LAN or WAN links or virtually any type of link suitable for transporting voice or data to and from the network 106. As will be appreciated, both the messaging system 126 and database 128 are logical entities that may be realized by unitary, centralized devices or multiple, distributed devices. The messaging system 126 and database 128 may be linked directly to the MSC 116 or central office switch 124, rather than (or in addition to) the network 106.

Turning now to FIG. 2, there is shown a flowchart of a method that may be implemented in the communication system of the type shown in FIG. 1, for a calling party to effect expedited no-answer treatment during a ring sequence of a called party phone. The steps of FIG. 2 are implemented, where applicable, using stored software routines within a calling party phone, MSC 116 and/or central office switch 124.

At step 202, the calling party dials a directory number of a called party phone, as is well known in the art, to initiate a call to the called party phone. The calling party and the called party may comprise any combination of wireless or wireline phones. At step 204, the originating office (i.e., serving the calling party phone) receives the call and routes the call to the terminating office (i.e., serving the called party phone). For example, in the case of a call initiated by a mobile unit 108 and directed to wireline unit 110, MSC 116 receives the call and routes the call to the central office switch 124. Conversely, in the case of a call initiated by a wireline unit 110 and directed to mobile unit 108, central office switch 124 receives the call and routes the call to the MSC 116. Of course, it is also possible that a call will be invoked entirely within the wireless subsystem 102 or wireline subsystem 104, in which case either the MSC 116 or central office switch 124, as the case may be, may both receive the call and serve as the terminating office.

At step 206, the terminating office checks the status of the called party phone and, if the phone is not busy, commences a ring signal to the called party phone. Typically, the ring signal comprises a predefined sequence of rings (usually at least 3-4 rings) over a time period of several seconds, although the ring signal may be shorter or longer for different users based on network and/or user settings. If the ring sequence is concluded without the called party answering the phone, the terminating office effects no-answer treatment which, depending on user settings, may comprise directing the call to voice mail or to a forwarding number.

Historically, there was no mechanism (other than hanging up) for the calling party to interrupt the ring sequence. Consequently, if the calling party desired no-answer treatment, it was necessary for the calling party to endure the ring sequence for several seconds before getting no-answer treatment. Moreover, the calling party generally does not know the type of no-answer treatment associated with the called party phone. For example, the calling party might await conclusion of the ring sequence in the expectation of leaving a voicemail message, but the no-answer treatment that actually occurs after the ring sequence might) not provide the opportunity to leave a voicemail message.

In the embodiment of FIG. 2, as indicated at step 208, the calling party enters a code on his or her phone, indicating a desire to interrupt the ring sequence and effect expedited no-answer treatment. Alternatively, the calling party might request expedited no-answer treatment by pressing a button, using a point-and-click method or using generally any other appropriate user interface depending on the structure of the calling party phone.

In one embodiment, the request effects a “default” no-answer treatment that is nominally associated with the called party phone. In such case, for example, if voicemail is the type of no-answer treatment that is offered to the calling party after the ring sequence is concluded, the request for expedited no-answer treatment will also direct the calling party to voicemail, albeit quicker than would otherwise occur. Alternatively, the calling party may request a desired type of no-answer treatment, which may differ from the default no-answer treatment that would otherwise occur at the called party phone. Thus, for example, the calling party might request “direct” voicemail, even though the default no-answer treatment may not comprise voicemail. In such manner, the called party may leave a voicemail message even though voicemail would not otherwise have been offered to the calling party. Further, even in the case where voicemail is the default no-answer treatment of the called party phone, the calling party does not ordinarily know so in advance, thus providing an ability for the calling party to request direct voicemail not only saves time but also provides certainty to the calling party.

In one embodiment, multiple types of no-answer treatment are available to the calling party. It is contemplated that separate codes or signals might be used for the different types of treatment available such that the calling party, depending on the code entered, may select a certain type of no-answer treatment from the multiple available types. Moreover, where applicable, the codes may correspond to types of call treatment that are not normally used at the end of a ring sequence. For example, a first code (e.g., #41) might be used to request a call treatment that is normally associated with a busy call; a second code (e.g., #42) may request default no-answer treatment associated with the called party phone; a third code (e.g., #43) may request direct voicemail. Still further, the options might allow the calling party to specify distinctive rings, and so forth. For example, a fourth code (e.g., #44) may request a quick ring before forwarding to voice mail or call forwarding. As will be appreciated, virtually any number of options may be provided other than the examples herein.

At step 210, the calling party request is forwarded to the terminating office, which determines the appropriate no-answer treatment based on the request and, at step 212, the call is routed per the appropriate no-answer treatment.

In one embodiment, the calling party request is interpreted as a request for default no-answer treatment associated with the called party. In such case, the terminating office at step 210 consults a subscriber database (e.g., database 128) to identify a default no-answer treatment associated with the called party and, at step 212, provides the default no-answer treatment. For example, in the case where the default no-answer treatment comprises voicemail, the terminating office terminates the ring sequence and directs the calling party to the messaging system 126 at step 212.

In one embodiment, the request identifies a calling party preferred type of no-answer treatment. The preferred no-answer treatment may be selected from among a plurality of call treatment options, as has been described in relation to step 208. Responsive to receiving the request, the terminating office at step 210 consults a subscriber database (e.g., database 128) to identify an availability of the called party preferred no-answer treatment and, if the preferred treatment is available, the terminating office provides the called party preferred no-answer treatment at step 212. Optionally, if the calling party preferred no-answer treatment is not available, the calling party consults the subscriber database to identify a default no-answer treatment associated with the called party and, at step 212, provides the default no-answer treatment.

FIG. 3 is a flowchart of a second embodiment of the invention. The steps of FIG. 3 are implemented, where applicable, using stored software routines within a calling party phone, MSC 116 and/or central office switch 124.

At step 302, a calling party enters a code on his or her phone, indicating a request to invoke expedited no-answer treatment. In one embodiment, the request identifies a preferred type of treatment. The preferred treatment may be selected from multiple call treatment options including but not limited to the options described in relation to FIG. 2. At step 304, the calling party dials a directory number of a called party phone. In the preferred embodiment, step 302 is accomplished prior to or substantially simultaneously with step 304, such that the calling party may invoke expedited no-answer treatment in advance of ringing the called party phone.

As will be appreciated, the calling party and the called party may comprise any combination of wireless or wireline phones. Moreover, alternatively to entering a code, the calling party might invoke expedited no-answer treatment by pressing a button, using a point-and-click method or using generally any other appropriate user interface depending on the structure of the calling party phone. At step 306, the originating office (i.e., serving the calling party phone) receives the call and routes the call to the terminating office (i.e., serving the called party phone) substantially as has been described in relation to FIG. 2. Optionally, at step 308, the terminating office commences a ring signal to the called party phone. The ring signal, if applied, is preferably an abbreviated “quick-ring” or distinctive ring sequence.

At step 310, the terminating office provides fast forward no-answer treatment, based on the request of the calling party and availability of the requested treatment. The call is routed per the requested treatment, if available, at step 312. In one embodiment, the terminating office at step 310 consults a subscriber database (e.g., database 128) to identify the availability of the requested treatment, substantially as has been described in relation to FIG. 2. Optionally, if the requested no-answer treatment is not available, the calling party consults the subscriber database to identify a default no-answer treatment associated with the called party and provides the default treatment at step 312.

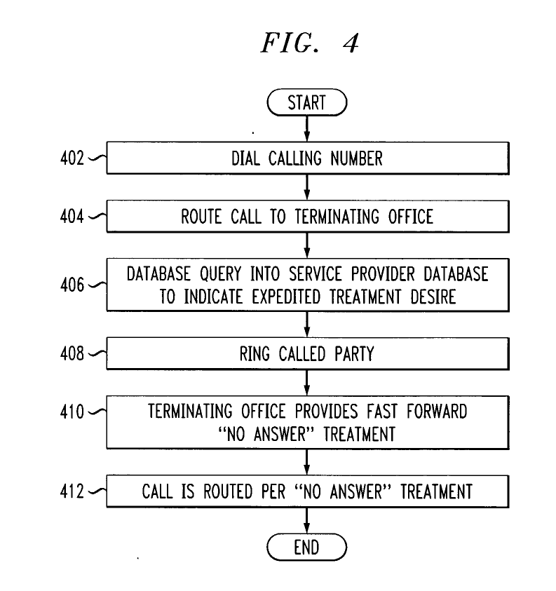

Now turning to FIG. 4, there is shown a flowchart of a third embodiment of the invention wherein a service provider effects expedited no-answer treatment of a called party phone. The steps of FIG. 4 are implemented, where applicable, using stored software routines within a calling party phone, MSC 116 and/or central office switch 124. The method relies upon a database constructed by (or for) the service provider mapping a plurality of subscribers to various default no-answer treatments. The default treatments may be based on request(s) from subscribers and/or autonomous allocations by the service provider. For example, a service provider may provision the database to identify default treatments for a single directory number (DN), a group of DNs, an office wide telephone system, etc.

At step 402, a calling party dials a directory number of a called party phone. At step 404, the originating office (i.e., serving the calling party phone) receives the call and routes the call to the terminating office (i.e., serving the called party phone) substantially as has been described in relation to FIG. 2. At step 406, the terminating office consults the service provider database to identify the type of treatment (i.e., the default treatment) to use for the called party phone. Optionally, at step 408, the terminating office commences a ring signal to the called party phone. The ring signal, if applied, is preferably an abbreviated “quick-ring” or distinctive ring sequence. At step 410, the terminating office provides fast forward no-answer treatment, based on the default treatment of the calling party identified in the service provider database. The call is routed per the default treatment at step 412.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising the steps of:
receiving a call initiated from a calling party and directed to a called party;
commencing a ring sequence associated with the call;
during the ring sequence, receiving a request from the calling party for expedited no-answer treatment for the call;
responsive to the request, interrupting the ring sequence and providing no-answer treatment for the call.

2. The method of claim 1, wherein the step of providing no-answer treatment comprises directing the call to a voice mailbox of the called party.

3. The method of claim 1, wherein the step of providing no-answer treatment comprises directing the call to a forwarding number of the called party.

4. The method of claim 1, comprising, responsive to receiving the request for expedited no-answer treatment,
consulting a subscriber database to identify a default no answer treatment associated with the called party; and
providing the default no-answer treatment.

5. The method of claim 1, wherein the request for expedited no-answer treatment identifies a calling party preferred no-answer treatment, the method comprising, responsive to receiving the request,
consulting a subscriber database to identify an availability of the calling party preferred no-answer treatment; and
if the calling party preferred no-answer treatment is available, providing the calling party preferred no-answer treatment.

6. The method of claim 5, further comprising, if the calling party preferred no-answer treatment is not available,
consulting a subscriber database to identify a default no answer treatment associated with the called party; and
providing the default no-answer treatment.

7. The method of claim 5, wherein the calling party preferred no-answer treatment is selected from a plurality of call treatment options.

8. A method comprising the steps of:
receiving a call initiated from a calling party and directed to a called party;
receiving a request from the calling party for a preferred type of no-answer treatment for the call, thereby defining a calling party preferred no-answer treatment;
determining an availability of the calling party preferred no-answer treatment; and
if the calling party preferred no-answer treatment is available, providing the calling party preferred no-answer treatment.

9. The method of claim 8, wherein the step of receiving a request for a preferred type of no-answer treatment occurs prior to a ring sequence nominally associated with the call.

10. The method of claim 8, wherein the step of determining an availability of the called party preferred no-answer treatment comprises consulting a subscriber database.

11. The method of claim 8, further comprising, if the calling party preferred no-answer treatment is not available,
consulting a subscriber database to identify a default no answer treatment associated with the called party; and
providing the default no-answer treatment.

12. The method of claim 8, wherein the calling party preferred no-answer treatment is selected from a plurality of call treatment options.

13. A method comprising the steps of:
constructing a database mapping each of a plurality of subscribers to a default no-answer treatment;
receiving a call initiated from a calling party and directed to one of the plurality of subscribers, the one of the subscribers thereby defining a called party;
consulting the database to identify the default no-answer treatment associated with the called party; and
routing the call per the default no-answer treatment associated with the called party.

14. The method of claim 13, wherein the step of constructing a database comprises:
receiving, from at least a first subscriber of the plurality of subscribers, a preferred no-answer treatment; and
mapping a directory number of the first subscriber to the preferred call treatment, the preferred call treatment thereby defining the default no-answer treatment of the first subscriber.

15. The method of claim 13, wherein the step of constructing a database comprises:
allocating, by the service provider, default no-answer treatments associated with one or more subscribers of the plurality of subscribers; and
mapping respective directory numbers of the one or more subscribers to the default no-answer treatment.

16. The method of claim 15, wherein the step of allocating default no-answer treatments is accomplished responsive to a network loading condition.
